(19) United States
(12) Patent Application Publication
(10) Pub. No.: US 2015/0112542 A1
(43) Pub. Date: Apr. 23, 2015

(54) TRANSPORTATION EVENT RECORDER FOR VEHICLE

(71) Applicant: XRS Corporation, Eden Prairie, MN (US)

(72) Inventor: Daniel P. Fuglewicz, Getzville, NY (US)

(73) Assignee: XRS Corporation, Eden Prairie, MN (US)

(21) Appl. No.: 14/061,456

(22) Filed: Oct. 23, 2013

(51) Int. Cl. G07C 5/08

(52) U.S. Cl. CPC G07C 5/085; G07C 5/0816
USPC 701/32.2; 701/1

(57) ABSTRACT

A device includes a non-transitory computer readable data storage media, a connector configured to receive vehicle data from a vehicle, a sensor module configured to receive dynamic motion data from a motion sensor mounted within the vehicle, and a processor. The processor is configured to record, on the transitory computer readable data storage media during operation of the vehicle, vehicle data received via the connector and motion sensor data received from the motion sensor in combination with chronological information that facilitates a combined chronological reproduction of the vehicle data and the motion sensor data.

### TECHNICAL FIELD

This disclosure relates to techniques for recording data associated with transportation events in a vehicle.

### BACKGROUND

Fleet vehicle operators have an interest in keeping track of the vehicles and shipments, for compliance with governmental regulations, monitoring cargo, as well as monitoring the performance and well-being of their drivers. Fleet vehicles may be equipped with devices that are configured to track the vehicles' geographic locations, speeds, headings, cargo, cargo temperature, engine/vehicle performance parameters, and other data. Such information is used, for example, to maintain the vehicles, estimate delivery times, provide warning of possible damage to cargo, and to evaluate driver performance.

### SUMMARY

This disclosure is directed to techniques for recording data associated the operation of a vehicle. The disclosed techniques further include recording the data from the at least two sources with chronological information that facilitates a combined chronological reproduction of the data from the at least two sources. In some examples, the disclosed techniques further include detection of dangerous events, such as a crash event, during operation of the vehicle, and upon detecting the dangerous event, memorializing the data from the at least two sources that is in temporal proximity to the dangerous event.

In one example, this disclosure is directed to a method comprising recording, during operation of a vehicle, via a first data connection, vehicle data from the vehicle, and recording, during operation of the vehicle, via a second data connection, motion sensor data from an motion sensor mounted within the vehicle. The recorded motion sensor data and vehicle data includes chronological information that facilitates a combined chronological reproduction of the vehicle data and the motion sensor data.

In another example, this disclosure is directed to a device comprising a non-transitory computer readable data storage media, a connector configured to receive vehicle data from a vehicle, a sensor module configured to receive motion sensor data from an motion sensor mounted within the vehicle, and a processor. The processor is configured to record, on the transitory computer readable data storage media during operation of the vehicle, vehicle data received via the connector and motion sensor data received from the motion sensor in combination with chronological information that facilitates a combined chronological reproduction of the vehicle data and the motion sensor data.

In a further example, this disclosure is directed to non-transitory computer readable medium storing instructions configured to cause a programmable processor to record, during operation of a vehicle, via a first data connection, vehicle data from the vehicle, and record, during operation of the vehicle, via a second data connection, motion sensor data from an motion sensor mounted within the vehicle. The recorded motion sensor data and vehicle data includes chronological information that facilitates a combined chronological reproduction of the vehicle data and the motion sensor data. The instructions are further configured to cause the programmable processor to monitor at least one of the vehicle data and the motion sensor data to detect dangerous events during operation of the vehicle, upon detecting the dangerous event, memorialize the vehicle data and the motion sensor data that is in temporal proximity to the dangerous event, and purge the recorded vehicle data and motion sensor data that is not associated with a detected dangerous event.

The details of one or more implementations are set forth in the accompanying drawings and the description below. Other features and advantages may be apparent from the description and drawings, and from the claims.

### BRIEF DESCRIPTION OF THE DRAWINGS

FIG. 1 is a conceptual illustration of an example a fleet management system.

FIG. 2 is a conceptual illustration of driver and vehicle information communications for a single vehicle in the fleet management system of FIG. 1 in further detail.

FIG. 3 is a conceptual illustration of the system of FIG. 2 in combination with an external storage device.

FIG. 4 is a conceptual illustration of the system of FIG. 2 illustrating additional components for recording data from at least two sources with chronological information that facilitates a combined chronological reproduction of the data from the at least two sources.

FIG. 5 is a conceptual illustration of a memorialized data record associated with a dangerous event of a vehicle.

FIG. 6 is a flowchart illustrating techniques for recording, during operation of a vehicle data from at least two sources with chronological information that facilitates a combined chronological reproduction of the data from the at least two sources.

### DETAILED DESCRIPTION

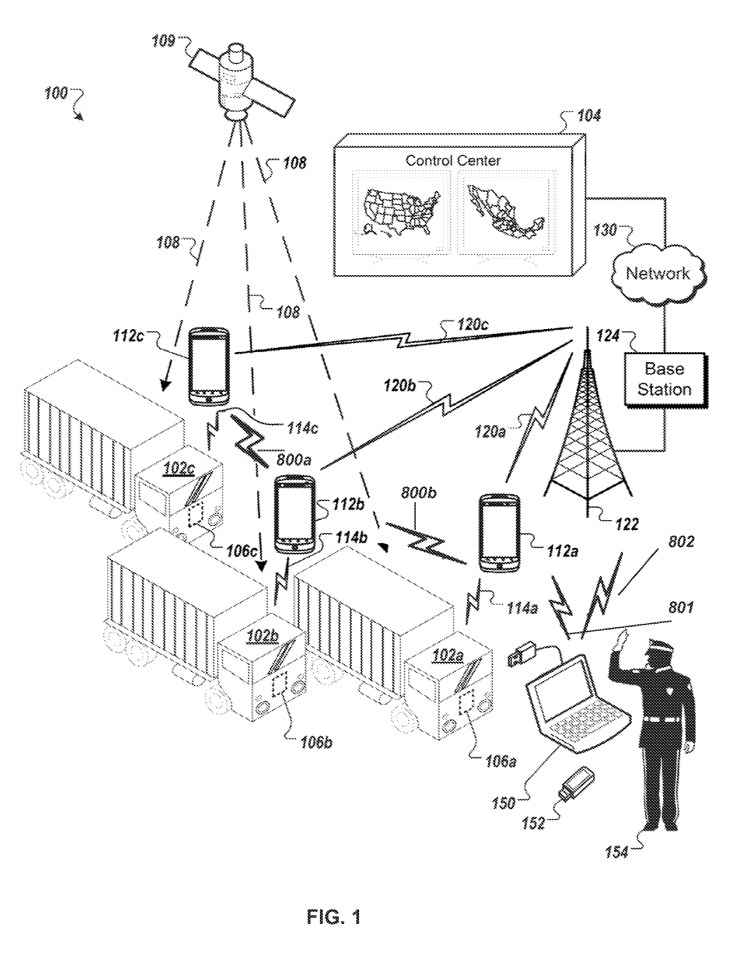

FIG. 1 illustrates an example fleet management system 100. Fleet management system 100 includes a collection of vehicles 102a-102c equipped with data acquisition devices 106a-106c and accompanying portable wireless data transfer and display devices 112a-112c. In particular, examples, portable wireless data transfer and display devices 112a-112c may be cellular phones or other commercially available long-range wireless communication devices. Fleet management system 100 further includes control center 104, which facilitates remote monitoring of vehicles 102a-102c.

Data acquisition devices 106a-106c are configured to mount inside vehicles 102a-102c and provide a connection to the vehicles for gathering vehicle data from the vehicle during operation of the vehicle. This vehicle data may then be forwarded to the corresponding data transfer and display devices 112a-112c. Portable wireless data transfer and display devices 112a-112c each include a user interface, which may be used to receive information from the driver and/or present vehicle and other information to the driver. The user interfaces of the portable wireless data transfer and display devices may be configured to present at least one of: the vehicle data, the driver information, the driver communications, data associated with dangerous events, or a driver summary electronic report.

In some examples, data acquisition devices 106a-106c may be configured to record data associated the operation of vehicles 102a-102c from at least two sources, such as vehicle data from an engine control module (ECM) or other source as well as motion sensor (or other dynamic motion sensor) data. In such examples, data acquisition devices 106a-106c may be configured to record the data from the at least two sources with chronological information that facilitates a combined chronological reproduction of the data from the at least two sources. Data acquisition devices 106a-106c may also be configured to detect dangerous events, such as a crash event, during operation of their respective one of vehicles 102a-102c, and upon detecting the dangerous event, memorializing the data from the at least two sources that is in temporal proximity to the dangerous event. Data acquisition devices 106a-106c may also be configured to purge at least a portion the recorded vehicle data and motion sensor data that is not associated with a detected dangerous event. Motion sensor data may include data from one or more linear accelerometers, rotational accelerometers, global positioning system (GPS) receivers

Portable wireless data transfer and display devices 112a-112c communicate with a remote network device of control center 104. Control center 104 represents a physical or conceptual location in which vehicle information about vehicles 102a-102c, along with the vehicle's driver information, their driver communications, data associated with dangerous events, and driver summary electronic reports of their work history, is collected and used.

Remote control center 104 is configured to receive the vehicle data, the driver information, the communication information, the data associated with dangerous events, and the driver summary electronic report, at predetermined times, such as at real-time or at intervals that approximate real-time, from portable wireless data transfer and display devices 112a-112c through long-range network 120a-120c. The network device then presents at least one of the vehicle data, the driver information, the communication information, or the summary electronic report to a user via a display.

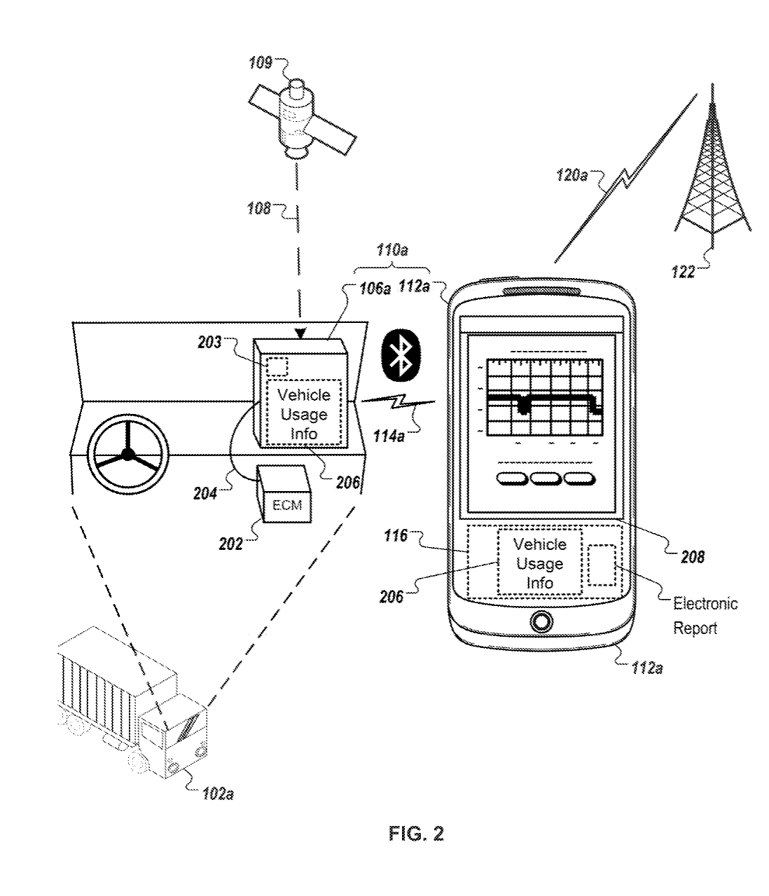

As mentioned previously, data acquisition devices 106a-106c are electronic devices that collect vehicle data about vehicles 102a-102c, such as location, speed, operational parameters, acceleration, operating hours, and/or other vehicle-related information. For example, data acquisition devices 106a-106c may receive location information such as GPS signals 108 from GPS satellites 109 to determine the locations, speed, and heading of their respective vehicles 102a-102c. Also, data acquisition device 106a-106c may be configured to electrically connect with an engine control module (refer to FIG. 2) so as to receive vehicle operation information, e.g., road or engine speed, operational parameters, acceleration/braking data, fuel usage, and the like, for storage within a memory module and through usage of devices such as motion sensors.

In some examples, the connection to the vehicle may be a wired connection; in other examples, the connection to the vehicle may be a wireless connection. Periods of operation of the vehicle may include periods when the vehicle is in motion, idle, or while any electronic component of the vehicle is active. In some examples, data acquisition devices 106a-106c may be free of a user interface display altogether. Instead, data acquisition devices 106a-106c may interact with a user, such as a driver, via one of portable wireless data transfer and display devices 112a-112c.

In some examples, each data acquisition device 106 includes a short-range wireless communication module configured to wirelessly transmit vehicle data to a corresponding portable wireless data transfer and display device 112. The vehicle data may be transmitted at predetermined times, such as at real-time or at intervals that approximate real-time, e.g., intervals of less than 5 minutes, less than 3 minutes, less than 2 minutes, less than 1 minute or even less than 30 seconds. Likewise, the portable wireless data transfer and display devices 112a-112c may include a short-range wireless communication modules configured to wirelessly receive the vehicle data from a corresponding data acquisition device 106. This may occur at predetermined times, such as at real-time or at intervals that approximate real-time, when the data acquisition device is mounted in the vehicle and the portable wireless data transfer and display device is in close proximity to the vehicle. In other examples, communications between a data acquisition device and a portable wireless data transfer and display device may occur over a wired connection, such as a connection conforming to a universal serial bus (USB) standard, such as USB 1.1, USB 2.0, USB 3.0, FireWire, RS-232, or other wired connection. The portable wireless data transfer and display devices also include a communication module configured to provide a communication link with the remote network device via long-range wireless network 120a-120c.

Still referring to FIG. 1, each of data acquisition device 106a-106c may communicate with a corresponding portable wireless data transfer and display device 112a-112c, at predetermined times, such as at real-time or at intervals that approximate real-time, using a short-range wireless communication module, which may also be positioned inside or in close proximity to vehicle 102a-102c. These signals are received by the portable wireless data transfer and display devices through the devices own short-range wireless network communication modules. In particular, each of portable wireless data transfer and display devices 112a-112c may be carried by the driver of the corresponding vehicle 102a-102c.

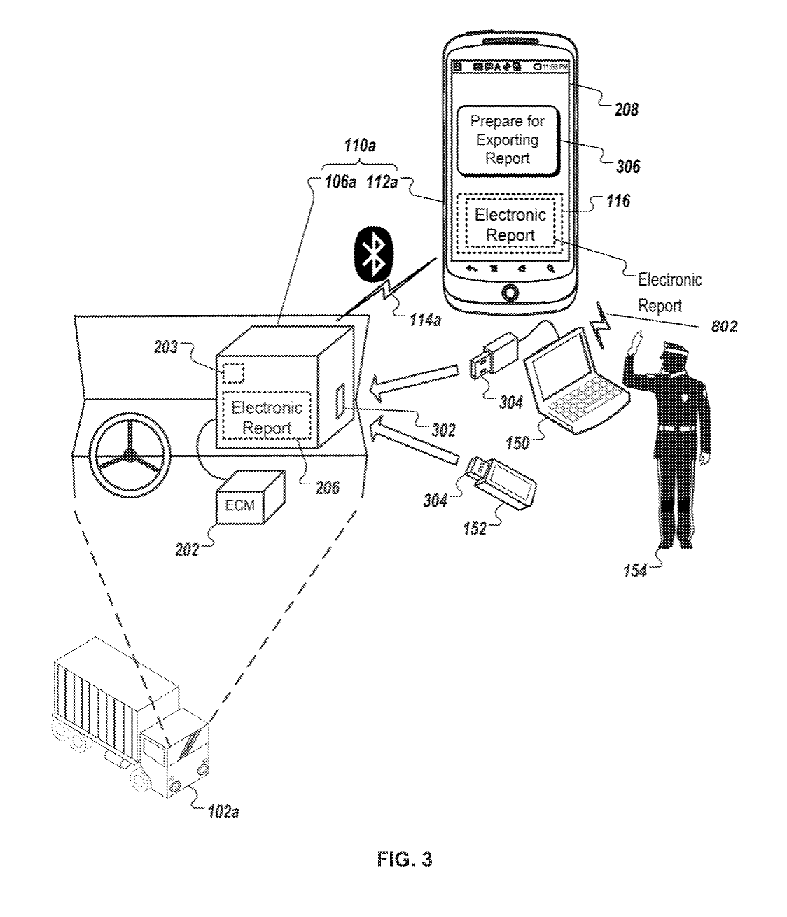

Each portable wireless data transfer and display device 112a-112c is configured to wirelessly communicate with a corresponding data acquisition device 106a-106c, respectively, mounted in the vehicle while the driver is operating the vehicle. For example, during use of fleet vehicle 102a, data acquisition device 106a and portable wireless data transfer and display device 112a may wirelessly communicate while both data acquisition device 106a and portable wireless data transfer and display device 112a are positioned inside vehicle 102a. In such circumstances, data acquisition device 106a and the corresponding portable wireless data transfer and display device 112a may operate as system 110a (FIGS. 2-3) for communicating information about vehicle 102a and its driver.

Still referring to FIG. 1, in this example, data acquisition device 106a communicates with portable wireless data transfer and display device 112a over short-range wireless link 114a. Portable wireless data transfer and display device 106a provides a user interface for data acquisition device 106a. Similarly, data acquisition devices 106b and 106c communicate with portable wireless data transfer and display devices 112b and 112c, respectively, over a short-range wireless links 114b and 114c. In those examples in which portable wireless data transfer and display device 112a-112c provides the user interface for the respective data acquisition device 106a-106c, each data acquisition device 106a-106c may be constructed as a displayless unit that is free of any user interface display mounted thereto, thereby reducing the size of data acquisition device 106a, e.g., providing for simplified installation and, optionally, concealed installation inside the vehicle, and reducing the manufacturing complexities for data acquisition device 106a. In some implementations, portable wireless data transfer and display devices 112a-112c may be cellular telephones, satellite telephones, portable computers, tablet computers, personal digital assistants (PDAs), or other mobile computing devices that are programmed to wirelessly communicate with one or more of data acquisition device 106a-106c. As such, each portable wireless data transfer and display device 112a-112c may be separately housed from its corresponding data acquisition device 106a-106c so that portable wireless data transfer and display device 112a-112c may be carried by the vehicle driver or other user outside of vehicle 102a-102c white data acquisition device 106a-106c remains mounted inside vehicle 102a-102c.

In some implementations, wireless links 114a-114c may be short-range wireless communications links, such as Bluetooth, wireless Ethernet (WiFi) including WiFi 802.11, ZigBee, near-field communications (NEC), infrared (IrDA), block linear turbo equalization (BLTE) or any other suitable short-range wireless communication link utilized by the short-range wireless communication modules utilized by the data acquisition devices and portable wireless data transfer and display devices.

In some examples, each portable wireless data transfer and display device 112a-112c may communicate two ways with an associated data acquisition devices 106a-106c. In such examples, the data acquisition device may receive the driver information from the portable wireless data transfer and display device, while the portable wireless data transfer and display device receives vehicle information from the data acquisition device. This may be done at predetermined times when both items are positioned inside vehicle 102a-102c, e.g., while data acquisition device 106a is mounted inside vehicle 102a and portable wireless data transfer and display device 112a is carried by the driver in the vehicle or otherwise temporarily placed inside the vehicle cabin. Moreover, because each portable wireless data transfer and display device 112a-112c is portable relative to its respective data acquisition device 106a-106c, the driver or other human user may view or input driver information on the user interface of portable wireless data transfer and display device 112a-112c both when the driver is seated inside the vehicle and when the driver is positioned outside the vehicle in proximity thereto, e.g., while inspecting the exterior of the vehicle, refueling, or sitting in a nearby building. Furthermore, even when the portable wireless data transfer and display device is outside the proximity thereto, the portable wireless data transfer and display device may still communicate wirelessly with remote control center 104 using a long-range wireless network 120a-120c and with other mobile communications devices using long-range wireless network 800a-800b.

In use, each wireless link 114a-114c transmits information between the respective data acquisition device 106a-106c and its corresponding portable wireless data transfer and display device 112a-112c. In some implementations, data acquisition devices 106a-106c do not provide their own user interfaces, e.g., displays, input buttons, but instead wirelessly communicate bi-directionally with portable wireless data transfer and display device 112a-112c to provide user interface functions for the overall mobile system 110a (refer, for example, to FIG. 2). For example, data acquisition device 106a may wirelessly communicate vehicle data through short range wireless link 114a so that portable wireless data transfer and display device 112a may update and display hours of service information on the display screen carried by the driver. In another example, data acquisition device 106a may determine the location of vehicle 102a and wirelessly communicate the location information to portable wireless data transfer and display device 112a so that portable wireless data transfer and display device 112a may display the location on a map. Example uses of portable wireless data transfer and display device 112a-112c as user interfaces for data acquisition device 106a-106c are discussed further in the descriptions of FIGS. 2-5.

In use, portable wireless data transfer and display devices 112a-112c may communicate with at least one control center 104 over a collection of wireless links 120a-120c with one or more transceivers 122. They may also communicate with one or more other portable wireless data transfer and display devices 112a-112c through long-range networks 800a-800b. Information that may be communicated among portable wireless data transfer and display devices and remote networks includes the vehicle data, the driver information, driver communications, the data associated with dangerous events, and driver summary electronic reports. The driver summary electronic reports may include identification information for the driver, and hours of service information for the driver. This information may be viewed on the displays of the portable wireless data transfer and display devices. In some implementations, wireless links 120a-120c and 800a-800b may be short-range links, such as WiFi etc., or long-range wireless links, such as cellular communication links, satellite communication links, WiMAX links, long term evolution (LTE) links, or any other suitable form of long-range wireless link that may communicate data among portable wireless data transfer and display devices 112a-112c and control center 104.

In an example, transceiver 122 may be a cellular antenna tower that is configured to provide cellular data links to a variety of cellular telephones within a particular geographic range. Transceiver 122 may be communicatively connected to base station 124. In some implementations, base station 124 may be a cellular data communications provider, satellite communications provider, or any other appropriate wireless communications provider.

Still referring to FIG. 1, a network 130 communicatively connects base station 124 with control center 104. In some examples, network 130 may include the Internet or other public or private data networks. In alternative examples in which one or more of portable wireless data transfer and display device 112a-112c include a satellite phone, at least one of tong-range wireless links 120a-120c may be a satellite communication link and transceiver 122 may be a satellite communication apparatus.

A mentioned previously, control center 104 exchanges information with data acquisition devices 106a-106c (via portable wireless data transfer and display devices 112a-112c) and the portable wireless data transfer and display devices monitor the status of vehicles 102a-102c and the drivers within. For example, control center 104 may track the locations of vehicles 102a-102c in order to estimate delivery or pickup times, or to coordinate the dispatch of vehicles 102a-102c to pick up a delivery, e.g., by dispatching vehicle 102a-102c closest to the pickup location. In another example, control center 104 may monitor vehicles' 102a-102c operating parameters to coordinate repairs or maintenance, e.g., monitor temperatures of refrigerated cargo, or monitor engine warning signals. Control center 104 may also receive or send information to portable wireless data transfer and display devices 114a-114c, including, but not limited to, vehicle data, driver information, communication information, data associated with dangerous events, and driver summary electronic reports, at predetermined times.

A remote network user may furthermore view this collection of information on a display screen of a remote device on network 130. The remote network user or control center 104 may find that certain portable wireless data transfer and display devices are out of date and may be configured to send electronic updates to portable wireless data transfer and display devices 112a-112c. Correspondingly, the portable wireless data transfer and display device may be configured to receive these updates and self-install them.

Another form of information generated by the system for communication to the network device is driver information, which may include data indicative of the hours of service when the driver is on duty on a particular day. In some implementations, the driver information may be automatically converted into driver summary electronic reports (including hours of service records, driver identification information, etc.) that are readily exportable via the USB port of data acquisition device 106a-106c (FIG. 3) or via wireless link 120a-120c of portable wireless data transfer and display device 112a-112c. In this example, these portable wireless data transfer and display devices may further relay information to each other through long-range networks 800a-800c or to control center 104 through long-range networks 120a-120c.

For example, data acquisition device 106a may collect the vehicle data over a period of time when a particular driver is using vehicle 102a, and data acquisition device 106a can, at predetermined times, such as at real-time or at intervals that approximate real-time, transfer this vehicle information to corresponding portable wireless data transfer and display device 112a linked thereto via Bluetooth connection 114a. Portable wireless data transfer and display device 112a may also access the driver information, either by input by the driver into the portable wireless data transfer and display device or by receiving driver information from another portable wireless data transfer and display device or control center 104. From there, the driver information may be wirelessly communicated via cellular link 120a to control center 104, wirelessly communicated via Bluetooth link 114a to data acquisition device 106a for subsequent exporting via the USB port to a remote device (refer to FIG. 3), wirelessly communicated via a cellular link to portable wireless data transfer and display device 112b-112c, wirelessly communicated to remote computer 150, or some combination of the aforementioned. Regarding the process for exporting vehicle data or driver information, such as data associated with dangerous events, via the USB port, data acquisition device 106a may be configured to output the data directly to a temporarily connected external computer device 150, e.g., a notebook computer, or a portable storage device 152, e.g., a USB thumb drive, a portable hard drive, provided by a vehicle inspector 154, e.g., a law enforcement official, a regulatory inspector, or the like. In such circumstances, the vehicle inspector 154 may conveniently plug the external computer device 150 or portable storage device 152 into the USB port provided by data acquisition device 106a to facilitate a transfer of the requested data from data acquisition device 106a. Thus, data acquisition device 106a and portable wireless data transfer and display device 112 are two separately housed instruments that act together as a system to generate and communicate the vehicle data and driver information associated with the driver. Additionally, external computer device 150 may acquire the requested data directly from portable wireless data transfer and display device 112a through network 801, or may receive the information from control center 104 through wireless network connection 802.

Communication among network devices, the data acquisition devices, the portable wireless display and transfer units, and other communication devices and computers may be configured to occur at predetermined times. In different examples, predetermined times may include consistent periodic intervals, real-time communication, and times corresponding to particular events such as: driver events, communication events, vehicle events, safety events, remote network device events, data acquisition device events, and portable wireless display and transfer unit events. Additionally, predetermined times may include times such as when the portable wireless data transfer and display device is connected to the long-range wireless network, and periodical intervals when the portable wireless data transfer and display device is connected to the long-range wireless network. This facilitates real-time or approximately real-time updates of driver and vehicle data at a remote computing device via control center 104. This may improve transportation management by improving the reliability and accuracy of driver and vehicle information available via control center 104.

FIG. 2 is a conceptual illustration of driver and vehicle information communications for a single vehicle in system 110a for communicating fleet vehicle information of FIG. 1 in further detail. Specifically, FIG. 2 illustrates data acquisition device 106a as mounted in vehicle 102a and portable wireless data transfer and display device 112a in further detail. Data acquisition device 106a is mounted in vehicle 102a and is electrically connected to engine control module (ECM) 202 of vehicle 102a vehicle 102a. In particular, data acquisition device 106a may include an input cable, e.g., data bus 204, which electrically connects to a mating connector of ECM 202 within vehicle 102a.

In some implementations, ECM 202 is an electronic device that monitors and/or controls various functions of vehicle 102a. For example, ECM 202 may monitor vehicle speed, engine speed, coolant temperature, vehicle mileage, cargo environmental parameters, and any other appropriate vehicle parameters. In this example, data acquisition device 106a is configured to mount directly to a dash component inside the cabin of vehicle 102a. As previously described, data acquisition device 106a may be a displayless unit that is without any user interface display screen, thereby reducing the size of the unit 106a and facilitating a simplified installation process. User interface 208 of portable wireless data transfer and display device 112a may be used as a portable user interface for data acquisition device 106a when the unit 106a communicates with portable wireless data transfer and display device 112a over Bluetooth connection 114a.

In some examples, data acquisition device 106a may be configured to record data associated the operation of vehicles 102a from at least two sources, such as vehicle data from ECM 202 or other source as well as motion sensor data. In such examples, data acquisition device 106a may be configured to record the data from the at least two sources with chronological information that facilitates a combined chronological reproduction of the data from the at least two sources. Data acquisition device 106a may also be configured to detect dangerous events, such as a crash event, during operation of vehicle 102a, and upon detecting the dangerous event, memorializing the data from the at least two sources that is in temporal proximity to the dangerous event. Data acquisition device 106a may also be configured to purge at least a portion the recorded vehicle data and motion sensor data that is not associated with a detected dangerous event.

In some examples, data acquisition device 106a may include a single printed circuit board upon which all of its electronic circuitry is mounted, thereby limiting the size and manufacturing complexities of the unit 106a. It should be understood from the description herein, that data acquisition device 106a is depicted as an enlarged size in FIGS. 2-3 for purposes of illustration only, and that the actual size of data acquisition device 106a may be significantly smaller. For example, in some examples, data acquisition device 106a has a maximum length of about 8 inches, a maximum width of about 6.5 inches, and a maximum height of about 1.5 inches. As mentioned previously, the data acquisition device may include a short-range communication module for sending the vehicle data in real-time to a portable wireless data transfer and display device. This occurs when the data acquisition device is mounted in the vehicle and the portable wireless data transfer and display device is within close proximity to the data acquisition device.

As referred to herein, real-time communications represent data pushed over a communication channel that is active once the data is collected. For example, data acquisition device 106a pushes vehicle data gathered to portable wireless data transfer and display device 112a over a preexisting connection. Of course, the actual time period for this “real-time” communication is a time period greater than zero. In some examples, the real-time communication is less than 1 second, and may also be less than 0.1 seconds, less than 50 milliseconds, less than 20 milliseconds, or even less than 20 milliseconds.

In some implementations, data acquisition device 106a may detect the particular type of communications protocol employed by ECM 202, and automatically adapt to the detected protocol in order to communicate with ECM 202. In these circumstances, data acquisition device 106a may be installed in any one of a number of different types of vehicles, e.g., a Class 8 large truck, a Class 1 car, or the like, and the installer's act of connecting cable 204 to the vehicle's ECM 202 may prompt the control circuitry of data acquisition device 106a to automatically recognize the type of vehicle in which it is installed. As such, some examples of data acquisition device 106a need not be manufactured or preprogrammed in a vehicle-specific manner.

For example, in some implementations, ECM 202 may implement a controller area network (CAN), a local interconnect network (LIN), a vehicle area network (VAN), FlexRay, domestic digital bus (D2B), IDB-1394, SmartWireX, MOST, SAE J1587, SAE J1708, SAE J1850, SAE J1939, ISO-9141, ISO-11783, ISO 15765-4, SPI, IIC, PCL4TRUCKS, or any other communications protocol for communicating with data acquisition device 106a through data bus 204. These communications may be further passed on to portable wireless data transfer and display device 112a which may further communicate as shown in FIG. 1. In such circumstances, data acquisition device 106a may detect the combination and/or signal levels implemented over data bus 204, may analyze incoming data traffic, and/or may query ECM 202 using various protocols and receive corresponding responses in order to determine the protocol in use by ECM 202.

In some implementations, the connector on the end of the data bus cable 204, e.g., the end that connects to ECM 202, may include a connection jack having more data lines than are provided by ECM 202. Multiple converters may be provided to adapt a subset of the port's data lines to a variety of configurations of data bus 204. For example, passenger cars and other “class 1” vehicles may provide a connector that is compliant with the on-board diagnostic (OBD) II specification, while large trucks and other “Class 8” vehicles may provide a connector that is compliant with the heavy-duty OBD (HDOBD) specification. In such examples, one converter may be provided to adapt the port to connect to OBDII data buses, and another may be provided to adapt the port to connect to HDOBD data buses. Data acquisition device 106a may sense the configuration of an attached converter to determine the appropriate protocol to use for communication with ECM 202.

In some examples, data acquisition device 106a may be configured to simultaneously communicate via multiple protocols at once of one or more engine control modules. For instance, data acquisition device 106a may be configured to communicate via the J1939 and J1708 protocols at the same time. This feature may be useful, for example, for a vehicle in which ECM 202 communicates in two different protocols, e.g., communicates some information (braking information) on one engine bus and other information, e.g., fuel information, on another engine bus. Also, this feature may be useful when a single vehicle includes multiple ECMs 202 that employed different protocols. Thus, data acquisition device 106a may to gather some vehicle information appears on one engine bus, and to gather other vehicle information on another engine bus. In one implementation, cable 204 may have a first set of wires that are configured to connect with a first ECM (or a first engine bus of an individual ECM) while a second set of wires are configured to mate with a second ECM (or a second engine bus of the individual ECM. Any such vehicle data attained through the ECM could be stored within memory of the data acquisition device.

Furthermore, in particular examples in which ECM 202 or engine bus 204 may not provide a direct odometer reading, data acquisition device 106a may be configured to interpret other engine parameters to create an “effective odometer reading” of vehicle 102a starting at the point when data acquisition device 106a was installed in vehicle 102a. For example, data acquisition device 106a may receive data indicative of vehicle speed, e.g., used in combination with an internal clock or timer of data acquisition device 106a, or data indicative of distance increments, e.g., distance pulses every 0.1 miles, so as to generate an “effective odometer reading” for vehicle 102a. Accordingly, system 110a may be used to comply with distance and odometer reporting requirements (via an electronic report) even if ECM 202 or engine bus 204 of vehicle 102a does not directly provide odometer readings. In addition, system 110a may prompt an installer or other user to manually input the vehicle odometer reading (as shown on the dash of the vehicle) when data acquisition device 106a is initially installed so that the “effective odometer reading” calculated by the system 110 is a substantially accurate estimation of the actual total mileage of vehicle 102a.

As described previously, data acquisition device 106a receives location information, such as GPS signals 108 from GPS satellites 109 to determine the location of vehicle 102a. For example, data acquisition device 106a may be equipped with a GPS receiver device that receives signals from GPS satellite 109 so that data acquisition device 106a may receive coordinate information, e.g., longitude and latitude coordinates, and time information, e.g., current time. In addition, in some examples, data acquisition device 106a may be equipped with one or more accelerometers 203 to detect particular types of vehicle movement, such as hard brakes, acceleration, and lane changes. Instances of this type of vehicle movement may be recorded by data acquisition device 106a may communicated to control center 104 via portable wireless data transfer and display device 112a for purposes of safety monitoring by a fleet manager or other system user. Thus, during operation of the vehicle, some examples of data acquisition device 106a may receive input information from a combination of ECM 202 of vehicle 102a, the GPS system, and the one or more internal accelerometers 203.

Still referring to FIG. 2, data acquisition device 106a collects information from the various inputs, e.g., ECM 202, the GPS system, and the one or more accelerometers 203, and stores the vehicle information as data in a computer-readable memory module 206 with chronological information that facilitates a combined chronological reproduction of the input data from at least two sources. As previously described, in this example, data acquisition device 106a may be displayless and thus has no user interface of its own with which to let a user view or interact with the vehicle information. Rather, in this example, data acquisition device 106a communicates the vehicle information from memory module 206 to portable wireless data transfer and display device 112a over Bluetooth connection 114a, and the vehicle data may be stored in a non-transitory computer-readable memory 116 of portable wireless data transfer and display device 112a. Portable wireless data transfer and display device 112a provides user interface 208 with which the user may access some or all the vehicle information.

In addition to displaying some or all of the vehicle data on portable wireless data transfer and display device 112a, the vehicle data may also be transmitted two ways with another electronic device or control center 104 for review and archiving or other purposes. For example, in some examples, portable wireless data transfer and display device 112a may communicate with transceiver 122 over cellular link 120a to wirelessly communicate the vehicle data to remote network 130. As such, data acquisition device 106a and portable wireless data transfer and display device 112a operate as a system 110a that is positionable inside vehicle 102a and that communicates information related to the vehicle and its driver. Moreover, at least the display portion, e.g., portable wireless data transfer and display device 112a, of system 110a may be portable relative to data acquisition device 106a and vehicle 102a, thereby permitting the user to view and input vehicle data or driver information even when the user is positioned outside the vehicle. Further, because each portable wireless data transfer and display device 112a-112c is portable relative to vehicles 102a-102c (FIG. it) and data acquisition device 106a-106c (FIG. 1), each portable wireless data transfer and display device 112a-112c may be configured to wirelessly communicate with any one of the nearby data acquisition device 106a-106c. For example, if the driver carrying portable wireless data transfer and display device 112a switches to vehicle 102b (FIG. 1) for a new workday, the driver's portable wireless data transfer and display device 112a may be configured to wirelessly communicate with data acquisition device 106b (FIG. 1) mounted inside that vehicle 102b for the workday.

Data acquisition device 106a, including the example depicted in FIG. 2 may include a number of additional safety and efficiency features. For one, the device may include a “black box” application for real-time recording of safety events data similar to what is seen in airplanes through flight data recorders. Just as in aviation, the accident data recorder may record vehicle parameters related to safety and may record information related to automobile accidents (for example, sudden changes in speed), material degradation, and automobile performance. The data acquisition device may further include a feature for the computation of International Fuel Tax Agreement (IFTA) data using tax algorithms dependent on the state, province or other jurisdictional boundary and nation the vehicle is within. The location of the vehicle may be determined, for example, by using one or more GPA satellites 109. The data acquisition device may also be configured to receive an input of safety settings by a party. For example, a company employing the driver and vehicle may wish to ensure that their drivers do not exceed a particular speed. In some examples, a data acquisition device may track of when a safety violation, such as speeding, hard stop, or otherwise has occurred. Many more nuanced or complicated configuration for safety system integration could be implemented, with the driver, the driver's permanent employer, or the cargo owner all implementing their own safety features into the data acquisition device.

Additionally, data acquisition device 106a may also include additionally be capable of wirelessly receiving and downloading updates from a portable wireless data transfer and display device unit 112a via wireless link 114a. Updates could be related to memory storage, the GPS receiver, the accident data recorder, or any other configurable features of data acquisition device 106a.

Referring now to FIG. 3, each data acquisition device 106a--106c may optionally be equipped with an external data port, e.g., a USB port, for exporting driver summary electronic reports or other data, such as data associated with dangerous events, to a temporarily connected external storage device, such as portable computer device 150, portable storage device 152, or the like. As described previously, data acquisition device 106a includes memory module 206 for storage of the vehicle information and other data, and portable wireless data transfer and display device 112a may receive the vehicle information and generate driver summary electronic reports, such as an electronic duty of file report. In some implementations, the driver summary electronic report stored in the memory 116 of portable wireless data transfer and display device 112a may be copied to data acquisition device 106a, e.g., via wireless link 114a, for subsequent access by a third party such as vehicle inspector 154. Similarly, portable wireless data transfer and display device 112a may be configured to utilize a processor to process vehicle data and driver information into a driver summary electronic report. Portable wireless data transfer and display device 112a may then wirelessly transmit the electronic report to a remote computer via a wireless network. As an example of such data, under some jurisdictions, law enforcement or regulatory inspectors may be authorized to request a copy of the data 206 in order to inspect the driver's record of duty to determine whether the driver is in compliance with laws that regulate the number of consecutive or cumulative hours the driver is permitted to be on duty in a given period. Thus, in some circumstances, the driver summary electronic report may be generated by and stored in portable wireless data transfer and display device 112a, and this driver summary electronic report may be wirelessly communicated to data acquisition device 106a prior to exporting the driver summary electronic report via the output data port 302 of data acquisition device 106a.

As mentioned previously, the portable wireless data transfer and display device may also transmit data associated with dangerous events and/or the driver summary electronic report directly to the remote device 150 via wireless network connection 802. In some examples in which a copy of the data associated with dangerous events and/or the driver summary electronic report is stored in both portable wireless data transfer and display device 112a and data acquisition device 106a, and the copies of these files may be updated or sync prior to exporting the driver summary electronic report via the output data port 302 of data acquisition device 106a or via wireless network connection 802 from portable wireless data transfer and display device 112a.

In the illustrated example, the vehicle inspector 154 may request that a copy of the data 206 be copied to the inspector's computer device 150 or the inspector's portable storage device 152. To facilitate communication between data acquisition device 106a and computer device 150 of portable storage device 152, computer device 150 or portable storage device 152 may be plugged into data output port 302 of data acquisition device 106a. As previously described, data output port 302 may be a USB port adapted to accept a USB connector 304 provided by any of computer device 150 and portable storage device 152.

Still referring to FIG. 3, in some examples, portable wireless data transfer and display device 112a may control the transfer of the data associated with dangerous events and/or the driver summary electronic report to the inspector's computer device 150 or the inspector's portable storage device 152. For example, the data associated with dangerous events, the driver summary electronic report and/or other data stored on data acquisition device 106a may be protected from exporting via data output port 302 until the user provides approval for the data transfer via user interface 208 of portable wireless data transfer and display device 112a. In such circumstances, data stored on data acquisition device 106a may be protected from unauthorized users, and furthermore, data files stored on data acquisition device 106a may be updated or synced with the data files stored on portable wireless data transfer and display device 112a prior to any file exporting operation via data output port 302. In this example, portable wireless data transfer and display device 112a may prompt the user, such as the driver or inspector 154, to initiate the file transfer process wirelessly or via direct connection from data acquisition device 106a to the inspector's computer device 150 or directly to the inspector's portable storage device 152 via user interface 208. User interface 208 of portable wireless data transfer and display device 112a may provide, for example, at least one control button 306 that receives the user input indicative of a command to initiate the file transfer process.

In some implementations, the user control button 306 may be a physical button, a touchscreen button, a selectable menu item, or any other user control mechanism on portable wireless data transfer and display device 112a. In other implementations, the control button 306 may be replaced or implemented with an input to detect a user gesture, a spoken command, e.g., speech recognition, or any other appropriate user action that portable wireless data transfer and display device 112a may detect as a user command. Additionally, portable wireless data transfer and display device 112a may wirelessly transmit the data or electronic report directly to computer device 150 via a short range wireless connection, wireless network connection 802 or using an interface similar to that required for transferring the data from data acquisition device 106a to USB connector 304 or data output port 302.

In response to activation of the user control button 306, system 110a initiates a process in which the data associated with dangerous events, the driver summary electronic report and/or other data file is at least partially transferred to data acquisition device 106a for purposes of storing a copy of the file at data acquisition device 106a or otherwise updating an older version of the file stored at data acquisition device 106a. After the current version of data associated with dangerous events, the driver summary electronic report and/or other data file is stored at both portable wireless data transfer and display device 112a and data acquisition device 106a, data associated with dangerous events, the driver summary electronic report and/or other data file may be exported via data output port 302 of data associated with dangerous events, the driver summary electronic report and/or other data file. The operation for transferring data associated with dangerous events, the driver summary electronic report and/or other data file to computer device 150 or to portable storage device 152 may be an automatic process that requires no further user input on portable wireless data transfer and display device 112a and data acquisition device 106a. For example, after the initial user input on the control button 306 of user interface 208, data associated with dangerous events, the driver summary electronic report and/or other data file may be automatically transferred via data output port 302 upon a proper connection with computer device 150 or to portable storage device 152. As such, the driver or the inspector 154 may plug the inspector's device 150 or 152 into the communication port 302 either before or after the driver activates the user control button 306, in which case a copy of the driver summary electronic report from data acquisition device 106a is transferred via data output port 302 to the inspector's device 150 or 152. When finished, the inspector's device 150 or 152, with data associated with dangerous events, the driver summary electronic report and/or other data file stored in the memory thereof, may then be disconnected from the communications port 302 and used by vehicle inspector 154.

Portable wireless data transfer and display device 112 may also receive configuration updates for data acquisition devices 106. For example, portable wireless data transfer and display device 112a may receive a configuration updates for data acquisition devices 106 and then forward the update to its associated data acquisition device 106a. Such an update may represent a firmware update for the data acquisition devices 106. In different examples, such a firmware update result in the data acquisition device 106 receiving different and/or additional information from the vehicle's ECM. Firmware updates for data acquisition devices 106 may otherwise changing the manner in which the data acquisition device 106 interacts with either the ECM or portable wireless data transfer and display devices or otherwise alter the manner in which data acquisition devices 106 process data.

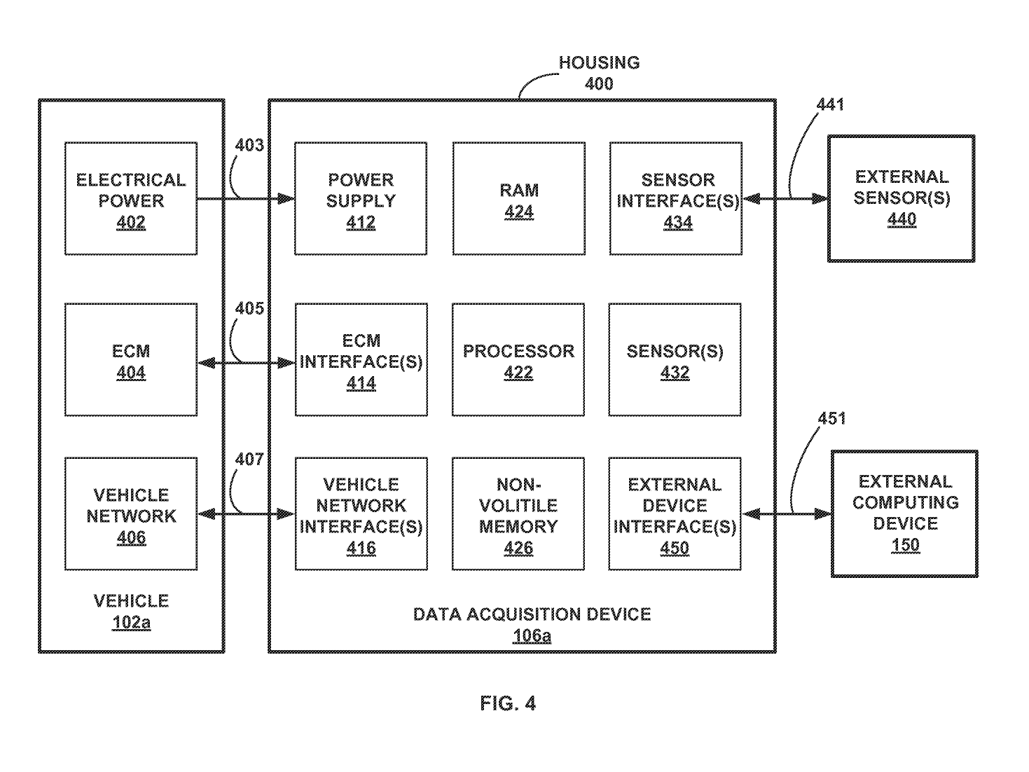

FIG. 4 is a conceptual illustration of the system of FIG. 2 illustrating additional components for recording data from at least two sources with chronological information that facilitates a combined chronological reproduction of the data from the at least two sources. In particular, FIG. 4 illustrates components of vehicle 102a, including electrical power 402, ECM 404, and vehicle network 406, operably connected to data acquisition device 106a.

Data acquisition device 106a includes power supply 412, which is operably connected to electrical power 402 of vehicle 102a via connection 403. For example, connection 403 may be a wired connection including a conductor providing a connection to the voltage of electrical power 402 of vehicle 102a.

Power supply 412 converts electrical power 402 of vehicle 102a into a form usable by the data acquisition device 106a. In some examples, power supply 412 may also protect data acquisition device 106a from vehicle power transients that might harm data acquisition device 106a. In the same or different examples, power supply 412 may include a rechargeable “energy reserve” in the form of batteries, super capacitors, or any type of power source, which is used to keep data acquisition device 106a powered in the event vehicle power is removed (e.g., in the event of a severe crash).

Data acquisition device 106a also includes ECM interface(s) 414, which includes a connector operably connected to ECM 404 of vehicle 102a via connection 405. Data acquisition device 106a optionally includes one or more vehicle network interface(s) 416 in addition to ECM interface(s) 414. Vehicle network interface(s) 416 include connector(s) or wireless interfaces operably connected to vehicle network 406 of vehicle 102a via connection 407. For example, connections 405, 407 may utilize one or more standardized “diagnostic ports” of vehicle 102a. In the same or different examples, connections 405, 407 may include direct connections into the vehicle data network wiring.

Both ECM interface(s) 414 and vehicle network interface(s) 416 contains the electronics to communicate with one or more types of vehicle data networks that exist on the vehicle. These networks include, but are not limited to controller area network (CAN), a local interconnect network (LIN), a vehicle area network (VAN), FlexRay, domestic digital bus (D2B), IDB-1394, SmartWireX, MOST, SAE J1587, SAE J1708, SAE 850, SAE J1939, ISO-9141, ISO-11783, ISO 15765-4, SPI, IIC, PCL4TRUCKS, or any other communications protocol for communicating with data acquisition device 106a.

Data acquisition device 106a receives vehicle information from ECM 404 and optionally from one or more addition vehicle networks 406. Examples of such vehicle information may include vehicle speed data, engine speed data, vehicle brake status, vehicle clutch status, vehicle throttle status, vehicle cruise control status, anti-lock brake status, anti-lock brake system data, rollover detection system data, engine control module data, and electronic instrument cluster data.

Data acquisition device 106a optionally includes one or more sensors 432. FIG. 4 further illustrates external sensors(s) 440 and external computing device 150. Data acquisition device 106a optionally includes sensor interface(s) 434, which are operably connected to external sensors(s) 440 via connection 441. External sensors(s) 440 are positioned within vehicle 102a or a trailer being pulled by vehicle 102a. In different examples, connection 441 may include a wired and/or wireless data connection.

Sensors 432 and/or external sensors 440 provide additional information that may be useful in detection and/or evaluation of a dangerous event. In some examples, sensors 432 and/or external sensors 440 may include a GPS receiver. In the event that sensors 432 include a GPS receiver, data acquisition device 106a must be located within vehicle 102a in a manner that allows reception of the GPS signal. In any event, such a GPS receiver would provide location, date, time and other information utilizing GPS satellite information. The GPS receiver may be similar to that used in Navigation Systems. The GPS receiver may provide latitude, longitude, and altitude (e.g., an absolute position reference) for the vehicle 102a.

In the same or different examples, sensors 432 and/or external sensors 440 may include a compass, such as a 3D compass. Such a 3D compass may provide the three Euler angles necessary to determine the absolute orientation of vehicle 102a. Assuming the orientation of the 3D compass mounted in the vehicle is known, then the 3D compass would provide data representing the absolute orientation of vehicle 102a.

In the same or different examples, sensors 432 and/or external sensors 440 may include an accelerometer, such as a 3D accelerometer. Such a 3D accelerometer may provide relative 3-dimensional linear movement information of vehicle 102a. If it is known how the 3D accelerometer is mounted in vehicle 102a, then the data provided by the 3D accelerometer would represent the relative 3-dimensional linear movement of vehicle 102a is also known. The acceleration data may also be integrated to determine the velocity of vehicle 102a over time, and the velocity over time may be integrated to get position of vehicle 102a over time. The position information provided by a 3D accelerometer may be combined with GPS information to provide further detail to the GPS position information. Whereas GPS data gives second-by-second location information, a 3D accelerometer can provide position data down to the millisecond (or better).

In the same or different examples, sensors 432 and/or external sensors 440 may include a gyroscope, such as a 3D gyroscope. Such a 3D gyroscope may provide relative 3-dimensional rotational movement information of vehicle 102a. If it were known how the 3D gyroscope is mounted in vehicle 102a, then the data provided by the 3D gyroscope would represent the relative 3-dimensional rotational movement of vehicle 102a. 3D gyroscopes usually provide rotational velocity data. This rotational velocity data may be differentiated to get rotational acceleration of vehicle 102a. The rotational velocity data from the 3D gyroscope may also integrated to provide relative orientation (i.e., angular position) information of vehicle 102a.

In each of these examples, sensor functionality may be combined (e.g., a 3D accelerometer/3D gyroscope combo), or could be split (e.g., (3) 1D accelerometers instead of (1) 3D accelerometer without changing the basic intent of the system. When data acquisition device 106a has access to both 3D accelerometer and 3D gyroscope data, the data may facilitate a complete six degree of freedom reconstruction of the location, velocity and acceleration of vehicle 102a at any point in time.

In the same or different examples, sensors 432 and/or external sensors 440 may include a pressure sensor, such as an absolute pressure sensor. Such an absolute pressure sensor may absolute barometric pressure information The absolute barometric pressure information can be converted to relative attitude changes. Absolute barometric pressure information may be used to augment altitude information provided by a GPS receiver. During a crash or dangerous event reconstruction, for example, the barometric pressure can be obtained for a specific location at a specific time from an outside source, e.g., from a weather station. Based on a comparison of the barometric pressure from the outside source, then absolute altitude can be determined using the absolute pressure sensor data.

In the same or different examples, sensors 432 and/or external sensors 440 may include a cellular receiver. The cellular receiver may also be used to provide position information for vehicle 102a, using cellemetry. In general, however, a GPS receiver can be expected to provide more precise position information than cellemetry techniques.

These specific sensors merely represent examples, and sensors 432 and/or external sensors 440 may include different or additional sensors not mentioned herein.

FIG. 4 further illustrates external computing device 150. In addition, data acquisition device 106a optionally includes external device interface(s) 450, which are operably connected to external computing device 150 via connection 451. In different examples, connection 451 may include wired or wireless connections, e.g., as discussed with respect to FIG. 3.

For example, external device interface(s) 434 may include a USB interface, UART interface, such as RS-232, RS-422, RS-485, Fire Wire, or any other type of wired serial connection, a Bluetooth interface, a Wi-Fi interface, a cellular interface, a different wired or wireless interface any combination thereof.

Data acquisition device 106a further includes processor 422, random access memory (RAM) 424 and non-volatile memory 426. Processor 422 provides the “computational engine” of data acquisition device 106a. Processor 422 may include any number of processing components including central processing units, microcontrollers, a system on a chip or other processing component embodied in hardware and/or software used for any computational aspect of data acquisition device 106a.

Random access memory (RAM) 424 represents a non-transitory computer readable data storage media utilized by processor 422 for various programmatic needs such as dynamic program storage, data storage, etc. RAM 424 may consist of any type of “volatile” memory, such as SDRAM, DDR2, DDR3, or other type of memory.

Non-volatile memory 426 represents a non-transitory computer readable data storage media utilized by processor 422 to store vehicle and sensor data, or other data, stored by data acquisition device 106a. In some examples, processor 422 may sometimes store vehicle data and/or sensor data within RAM 424 prior to transferring the vehicle data and/or sensor data to external computing device 150 via connection 451 and without storing the vehicle data and/or sensor data within non-volatile memory 426. In different examples, non-volatile memory may consist of flash, ferroelectric, battery-backed, or any other type of memory that retains its data after power is removed. Non-volatile memory 426 may also include read only memory (ROM) storing executable programs configured to run on processor 422. ROM may consist of any type of “fixed” memory such as ROM, EPROM, EEPROM, or Flash Memory. In other examples, such programs may be stored on rewriteable non-volatile memory.

Processor 422 is configured to collect vehicle data, such as vehicle speed data, engine speed data, vehicle brake status, vehicle clutch status, vehicle throttle status, vehicle cruise control status, anti-lock brake status, anti-lock brake system data, rollover detection system data, engine control module data, and electronic instrument cluster data, from ECM interface(s) 414 and/or vehicle network interfaces 416. Processor 422 is further configured o collect sensor data, such as motion sensor data, from onboard sensor(s) 432 and/or external sensor interfaces 434. Processor 422 is further configured to record the vehicle data and the sensor data in combination with chronological information that facilitates a combined chronological reproduction of the vehicle data and the sensor data.

Processor 422 may continuously read and record all data received from ECM 404, vehicle network 406, sensors 432 and external sensors 440, and, keep track of the time associated with all the data by using a real-time clock (i.e., “time-stamping” the data). For example, such data may be stored in RAM 424 and/or non-volatile memory 426. The data may be stored for a period of time and then purged. For example, the data may be stored for a defined period of time or until memory available for the storage of data may be stored in RAM 424 and/or non-volatile memory 426 is full, then the data may be overwritten on a first-in-first-out basis.

However, once processor 422 detects a dangerous event, e.g., based on monitoring of the data, processor 422 continues to collect for a determined period of time. Then the data that is in temporal proximity to the dangerous event, i.e., data before and after the dangerous event may be memorialized by storing such data in combination with chronological information that facilitates a combined chronological reproduction of the vehicle data and the motion sensor data in non-volatile memory 426 and/or by transfer to external device 150.

Data acquisition device 106a further includes housing 400, which encases the components of data acquisition device 106a, including non-volatile memory 426. Housing 400 is part of a crash survival design for data acquisition device 106. Data acquisition device 106a is intended to record data during and after a dangerous event, such as crash, near-rollover, sudden stop or sudden turn of vehicle 102a. For this reason, data acquisition device 106a is designed to survive most crashes. This means, at a minimum, data acquisition device 106a must withstand high accelerations. For example, data acquisition device 106a may be configured to protect non-volatile memory 426 from data corruption due to an acceleration of 50 g for 100 milliseconds, 25 g for 200 milliseconds and/or any other reasonable combination of acceleration level or a time period seen in vehicular crashes. In some examples, data acquisition device 106a may also be configured to survive exposure to moisture, heat from a vehicle fire, and/or crush protection.

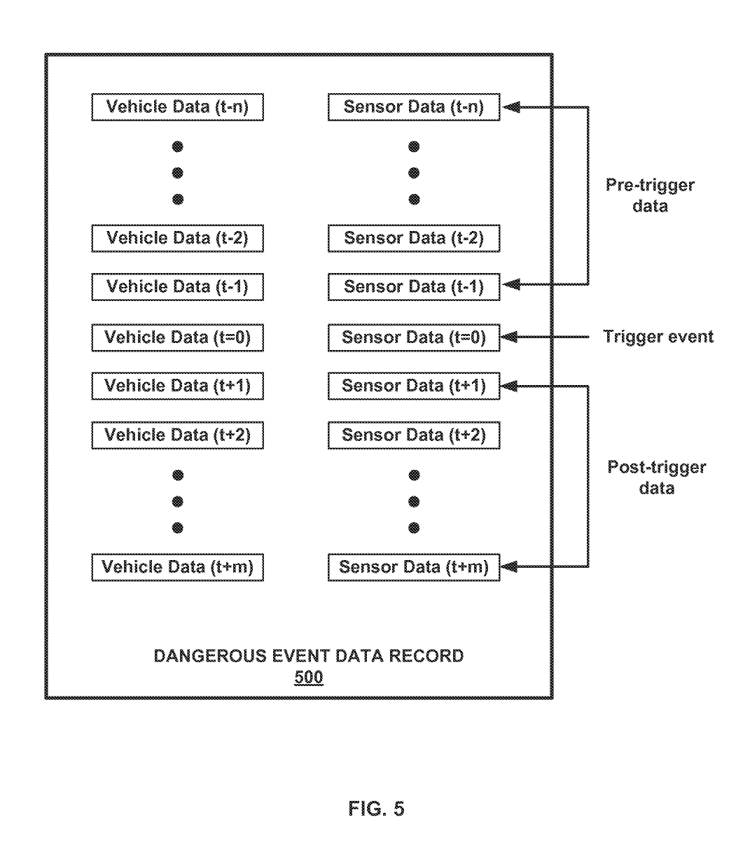

In the example of FIG. 5, data acquisition device 106a is depicted as being contained within a single assembly within a single housing 400, which may represent a plastic or metal case. In other examples, data acquisition device 106a may include more than one device that communicates via a wired or wireless means in a distributed configuration. In either case, the single or distributed data acquisition device 106a collects vehicle network and vehicle dynamics data in a manner that facilities a combined chronological reproduction of the vehicle data.

FIG. 5 is a conceptual illustration of a memorialized dangerous event data record 500 associated with a dangerous event of a vehicle. Dangerous event data record 500 includes vehicle data and sensor data, e.g., as described above with respect to FIG. 4 over a time interval associated with a dangerous event. For example, memorialized dangerous event data record 500 may be produced by processor 422 following the detection of a dangerous event. While only two separate data records are illustrated in dangerous event data record 500, additional data records may also be included. Generally speaking, dangerous event data record 500 may include substantially all data available from a vehicle's data networks during the time interval associated with a dangerous event as well as substantially all sensor data during the same time interval. Thus, dangerous event data record 500 may represent the most complete data record possible during the time interval associated with the dangerous event.

As illustrated in FIG. 5, “t=0” represents the point an event trigger was detected; “t+m” represents time after the trigger; “t−n” represents time before the trigger. The dangerous event data record 500 includes pre-dangerous event trigger data from time t=t₀−n to time t=t₀ as well as post-dangerous event trigger data from time t=t₀ to time t=t₀+m. In this manner, the dangerous event data record 500 includes a simultaneous record of vehicle data and sensor data from a vehicle before, during, and after a dangerous event, such as a crash event. Dangerous event data record 500 facilitates a combined chronological reproduction of the vehicle data and the sensor data from time t=t₀−n to time t−t₀+m.

In addition to the vehicle and sensor data, dangerous event data record 500 may also include identification and other non-operational information from the vehicle such as vehicle identification number (VIN), and ECU (electronic control unit) component ID, software version number, serial number, etc. This information may be collected for all ECUs on board the vehicle, and may be included as in the dangerous event data record 500 “header.” This information may allow analysts to more precisely analyze ECU performance by allowing easy identification of ECUs on the vehicle from dangerous event data record 500 itself.

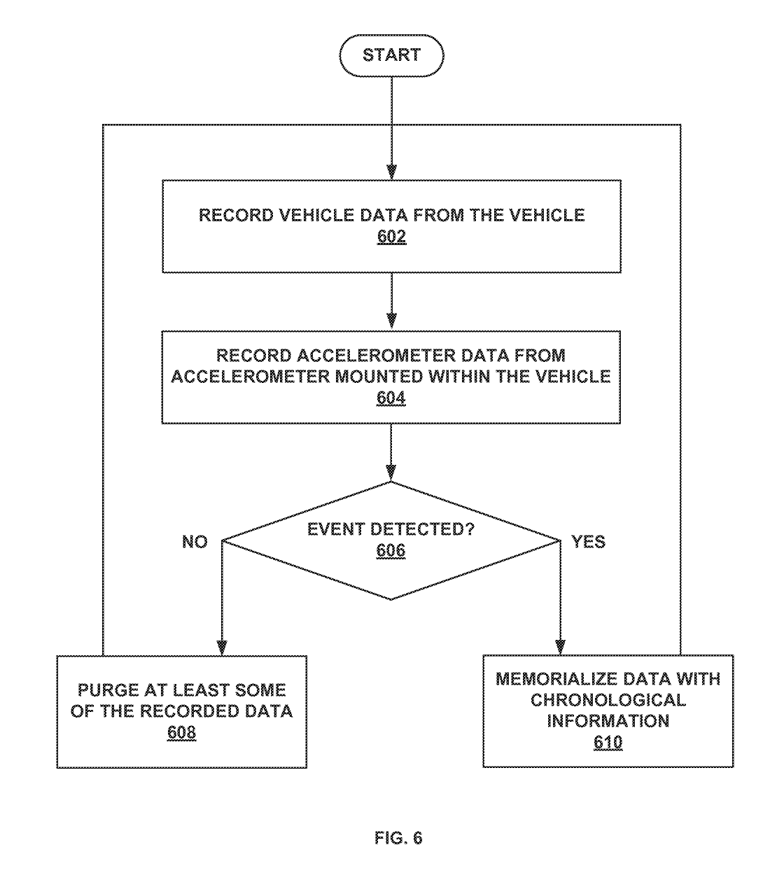

FIG. 6 is a flowchart illustrating techniques for recording, during operation of a vehicle data from at least two sources with chronological information that facilitates a combined chronological reproduction of the data from the at least two sources. For clarity, the techniques of FIG. 6 are described with respect to data acquisition device 106a, including processor 422 and vehicle 102a as shown in FIG. 4.

Processor 422 records, during operation of vehicle 102a, via data connection 405, vehicle data from the vehicle (602). Processor 422 also records, during operation of vehicle 102a, via a second data connection, such as a connection to sensors 432 or connection 441 to external sensors 440, motion sensor data from a motion sensor mounted within the vehicle (60.4). The recorded motion sensor data and vehicle data includes chronological information that facilitates a combined chronological reproduction of the vehicle data and the motion sensor data. Processor 422 also monitors at least one of the vehicle data and the motion sensor data to detect dangerous events during operation of vehicle 102a (606).

Upon detecting the dangerous event, processor 422 memorializes the vehicle data and the motion sensor data that is in temporal proximity to the dangerous event (610). Processor 422 may optionally purge the recorded vehicle data and motion sensor data that is not associated with a detected dangerous event (608). In some examples, processor 422 may transfer the memorialized vehicle data and the motion sensor data to a remote computing device, such as external computing device 150. In any event, processor 422 continues to record the vehicle data and the motion sensor data during operation of the vehicle, and processor 422 may memorialize data in temporal proximity to a plurality of dangerous events during the operation of the vehicle.

In different examples, processor 422 may monitor at least one of the vehicle data and the motion sensor data to detect dangerous events, including a crash of vehicle 102a, a rollover of vehicle 102a, a sudden stop of vehicle 102a, and a sudden turn of vehicle 102a.

In some examples, processor 422 may utilize one or more external triggers (e.g., a switch, pushbutton, etc., either integral to the system or remotely connected to data acquisition device 106a), which could be used by an operator to manually trigger the memorialization of data surrounding the trigger activation. In the same or different examples, such triggers could also be time-based (e.g., like a timer or alarm clock), or data-based (e.g., when the driver presses the accelerator or brake).

In addition to recording the vehicle data and the motion sensor data, processor 422 may also record, during operation of vehicle 102a, additional sensor data from a sensor mounted within the vehicle. The sensor data includes chronological information that facilitates chronological reproduction of the sensor data relative to the vehicle data relative and the motion sensor data. In some examples, such a sensor may include one or more of a GPS receiver, a gyroscope, a compass, and a pressure sensor.

Various implementations of the systems and techniques described here may be realized in digital electronic circuitry, integrated circuitry, specialty designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computer having a display, e.g., a CRT (cathode ray tube), LCD (liquid crystal display) monitor, touchscreen, or other display type, for displaying information to the user and an input devices, such as a touchscreen, a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback, and input from the user may be received in any form, including acoustic, speech, or tactile input.

The systems and techniques described here may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the systems and techniques described here, or any combination of such back end, middleware, or front end components. The components of the system may be interconnected by any form or medium of digital data communication, e.g., a communication network. Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

In some examples, a portable wireless data transfer and display device may provide limited functionality when it determines a vehicle is in operation or when it more specifically determines that its associated driver is operating a vehicle. A portable wireless data transfer and display device may determine the operational status of the vehicle and its associated driver via GPS signals, vehicle information, driver input, network communications or using any other information source provided to the portable wireless data transfer and display device as discussed herein or otherwise.

In some examples, portable wireless data transfer and display device may communicate only via sound, e.g., it may interact with the driver using voice communications. In other examples, the portable wireless data transfer and display device may not accept and driver input, or may only accept voice inputs, but may nonetheless continue to display information, such as route information, driver information and/or vehicle information automatically. In other examples, the portable wireless data transfer and display device may only provide important notifications. In yet another example, the portable wireless data transfer and display device may cease to interact when the vehicle is in operation.

In some examples, the portable wireless data transfer and display device may adjust the parameters of limited functionality according to the location or other operational parameter of the vehicle, e.g., in order to comply with local regulations and/or company policies, or to take into account the various operational limitations of vehicles of different sizes, weights, or other capabilities.

In some examples, the systems and techniques described herein may provide one or more of the following benefits. As one example, a data acquisition device may be equipped with an external data port, e.g., a USB connection port, so that the data acquisition device may output electronic reports or other electronic files via a hardwired connection to a remote computer. For example, a vehicle inspector may carry a portable computer device or portable storage device, and the driver, the inspector may plug the inspector's device into the data port of the data acquisition device on as to retrieve an electronic report, or other electronic files via a hardwired connection to the unit mounted in the vehicle.

In some examples, a system may provide a mobile communication device, e.g., a cellular phone, that provides short-range, two wireless communication with a data acquisition device mounted in a vehicle. In such circumstances, not only does the data acquisition device wirelessly communicate information to the mobile communication device, but the mobile communication device may also transmit information back to the data acquisition device. Therefore, one or more electronic files containing vehicle or driver information may be synced between the two separate devices for purposes of outputting the files in a number of optional manners. Furthermore, the mobile communication device may communicate electronic files containing vehicle or driver information to other mobile communication devices, remote computer(s), server(s), and other wireless displays.

In some examples, a data acquisition device mounted in the vehicle may be constructed as a display-less unit that is free of any user interface display. Such a construction may reduce the size of the data acquisition device, provide for simplified installation (and, in some examples, concealed installation inside the vehicle), and reduce the manufacturing complexities for the data acquisition device. In these circumstances, the user interface of the mobile communication device may serve as the user interface for the system (including the data acquisition device). As such, the mobile communication device may be separately housed from its corresponding data acquisition device so that the mobile communication device may be carried by the vehicle driver or other user outside of the vehicle while the data acquisition device remains mounted inside the vehicle. Moreover, because the mobile communication device is portable relative to its respective data acquisition device, the driver may view or input vehicle or driver information on the user interface of the mobile communication device both when the driver is seated inside the vehicle and when the driver positioned outside the vehicle in proximity thereto, e.g., while inspecting the exterior of the vehicle, refueling, or sitting in a nearby building. Furthermore, the driver may communicate through the mobile communication device with other devices connected to the network white the mobile device and driver are out of proximity required for short-range communication with the data acquisition device.

In some examples, a data acquisition device may be configured to detect the particular type of communications protocol employed by the vehicle, and automatically adapt to the detected protocol in order to communicate with an engine control module of the vehicle. As such, the data acquisition device may be installed in any one of a number of different types of vehicles, and the installer's act of connecting the data acquisition device to the vehicle's engine control module may prompt the control circuitry of the data acquisition device to automatically recognize the type of vehicle in which it is installed. In some examples, this protocol information may be further transmitted to a mobile communication device or portable wireless data transfer and display device, which may than communicate this information to other devices connected to the network.

In some examples, a data acquisition device may house one or more accelerometers therein so as to detect particular types of vehicle movement, such as hard brakes, acceleration, and lane changes. Instances of this type of vehicle movement may be recorded by the data acquisition device and communicated to a control center, e.g., via the mobile communication device, for purposes of safety monitoring by a fleet manager or other system user. This information may further be transmitted in real-time for better safety.

A number of examples have been described. Nevertheless, it may be understood that various modifications may be made without departing from the spirit and scope of this disclosure. Also, although several applications of the systems and methods have been described, it should be recognized that numerous other applications are contemplated. For example, although the techniques have been described in the context of road-based vehicles, the techniques may also be used with other transportation techniques such as motorcycles, bikes, pedestrians, snowmobiles, all-terrain vehicles, trains, planes, boats, or other transportation devices used for transportation of passengers and cargo.

Various examples have been described by way of this description and the accompanying figures. These and other examples are within the scope of the following claims.

What is claimed is:

1. A method comprising:
recording, during operation of a vehicle, via a first data connection, vehicle data from the vehicle; and
recording, during operation of the vehicle, via a second data connection, motion sensor data from a motion sensor mounted within the vehicle,
wherein the recorded motion sensor data and vehicle data includes chronological information that facilitates a combined chronological reproduction of the vehicle data and the motion sensor data.

2. The method of claim 1, further comprising:
monitoring at least one of the vehicle data and the motion sensor data to detect dangerous events during operation of the vehicle;
upon detecting the dangerous event, memorializing the vehicle data and the motion sensor data that is in temporal proximity to the dangerous event.

3. The method of claim 2, wherein the dangerous events include one or more of a group consisting of:
a crash of the vehicle;
a near-rollover of the vehicle;
a sudden stop of the vehicle; and
a sudden turn of the vehicle.

4. The method of claim 2, further comprising transferring the memorialized vehicle data and the motion sensor data to a remote computing device.

5. The method of claim 1, further comprising:
monitoring at least one of the vehicle data and the motion sensor data to detect dangerous events during operation of the vehicle; and
purging the recorded vehicle data and motion sensor data that is not associated with a detected dangerous event.

6. The method of claim 1, further comprising:
recording, during operation of the vehicle, location data from a global positioning system (GPS) receiver mounted within the vehicle,
wherein the recorded GPS data includes chronological information that facilitates chronological reproduction of the GPS data relative to the vehicle data relative and the motion sensor data.

7. The method of claim 1, wherein the motion sensor includes at least one of a group consisting of:
an accelerometer;
a gyroscope;
a compass; and
a pressure sensor.

8. The method of claim 1, further comprising:
recording, during operation of the vehicle, sensor data from a second sensor mounted within the vehicle,
wherein the sensor data includes chronological information that facilitates chronological reproduction of the sensor data relative to the vehicle data relative and the motion sensor data,
wherein the second sensor includes at least one of a group consisting of:
an accelerometer;
a gyroscope;
a compass; and
a pressure sensor.

9. The method of claim 1, wherein the vehicle data includes at least three of a group consisting of:
vehicle speed data;
engine speed data;
vehicle brake status;
vehicle clutch status;
vehicle throttle status;
vehicle cruise control status;
anti-lock brake status;
anti-lock brake system data;
rollover detection system data;
engine control module data; and
electronic instrument cluster data.

10. The method of claim 1, wherein the vehicle data includes substantially all data transmitted on vehicle data networks during operation of the vehicle.

11. The method of claim 1, wherein the first data connection operates according a protocol standard selected from a group consisting of
SAE J1587;
SAE J1708;
SAE J1939;
ISO 15765-4; and
PCL4TRUCKS.

12. A device comprising:
a non-transitory computer readable data storage media;
a connector configured to receive vehicle data from a vehicle;
a sensor module configured to receive motion sensor data from a motion sensor mounted within the vehicle; and
a processor configured to record, on the transitory computer readable data storage media during operation of the vehicle, vehicle data received via the connector and motion sensor data received from the motion sensor in combination with chronological information that facilitates a combined chronological reproduction of the vehicle data and the motion sensor data.

13. The device of claim 12, wherein the processor is further configured to:
monitoring at least one of the vehicle data and the motion sensor data to detect dangerous events during operation of the vehicle;
upon detecting the dangerous event, memorializing the vehicle data and the motion sensor data that is in temporal proximity to the dangerous event.

14. The device of claim 13, wherein the dangerous events include one or more of a group consisting of:
a crash of the vehicle;
a near-rollover of the vehicle;
a sudden stop of the vehicle; and
a sudden turn of the vehicle.

15. The device of claim 13, wherein the processor is further configured to transfer the memorialized vehicle data and the motion sensor data to a remote computing device.

16. The device of claim 13, wherein the processor is further configured to purge the recorded vehicle data and motion sensor data that is not associated with a detected dangerous event.

17. The device of claim 12, wherein the motion sensor includes at least one of a group consisting of:
an accelerometer;
a gyroscope;
a compass; and
a pressure sensor.

18. The device of claim 12, wherein the processor is further configured to:
recording, during operation of the vehicle, sensor data from a second sensor mounted within the vehicle,
wherein the sensor data includes chronological information that facilitates chronological reproduction of the sensor data relative to the vehicle data relative and the motion sensor data,
wherein the second sensor includes at least one of a group consisting of:
an accelerometer;
global positioning system (GPS) receiver;
a gyroscope;
a compass; and
a pressure sensor.

19. The device of claim 12, wherein the vehicle data includes at least three of a group consisting of:
vehicle speed data;
engine speed data;
vehicle brake status;
vehicle clutch status;
vehicle throttle status;
vehicle cruise control status;
anti-lock brake status;
anti-lock brake system data;
rollover detection system data;
engine control module data; and
electronic instrument cluster data.

20. The device of claim 12, wherein the vehicle data includes substantially all data transmitted on vehicle data networks during operation of the vehicle.

21. The device of claim 12, wherein the first data connection operates according a protocol standard selected from a group consisting of:
SAE J1587;
SAE J1708;
SAE J1939;
ISO 15765-4; and
PCL4TRUCKS.

22. The device of claim 12, wherein the connector is configured to mate with an engine control module of the vehicle.

23. The device of claim 12, wherein the device is configured to protect the non-transitory computer readable data storage media from data corruption under an acceleration of 50 g for 100 milliseconds.

24. A non-transitory computer readable medium storing instructions configured to cause a programmable processor to:
record, during operation of a vehicle, via a first data connection, vehicle data from the vehicle;
record, during operation of the vehicle, via a second data connection, motion sensor data from a motion sensor mounted within the vehicle,
wherein the recorded motion sensor data and vehicle data includes chronological information that facilitates a combined chronological reproduction of the vehicle data and the motion sensor data;
monitor at least one of the vehicle data and the motion sensor data to detect dangerous events during operation of the vehicle;
upon detecting the dangerous event, memorialize the vehicle data and the motion sensor data that is in temporal proximity to the dangerous event; and
purge the recorded vehicle data and motion sensor data that is not associated with a detected dangerous event.
